(19) United States
(12) Patent Application Publication
(10) Pub. No.: US 2010/0258654 A1
(43) Pub. Date: Oct. 14, 2010

(54) QUICK DISCONNECT SPRAY NOZZLE WITH TRANSVERSELY ORIENTED DISCHARGE ORIFICES

(75) Inventors: Lesli PETERSON, Glendale Heights, IL (US); Anthony Wood, Woodridge, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Spraying Systems Co., Wheaton, IL (US)

(21) Appl. No.: 12/759,855

(22) Filed: Apr. 14, 2010

Related U.S. Application Data
(60) Provisional application No. 61/169,042, filed on Apr. 14, 2009.

(51) Int. Cl. B05B 1/14; B05B 1/00

(52) U.S. Cl. 239/557; 239/590.5

(57) ABSTRACT

A spray nozzle is provided that includes a nozzle body. The nozzle body has a fluid passageway extending from an upstream opening in the nozzle body. The fluid passageway has a longitudinal axis. A plurality of spray tips are provided with each supported on the nozzle body. Each spray tip has a discharge orifice in communication with the fluid passageway and configured to discharge fluid in a direction that is transverse to the longitudinal axis of the fluid passageway.

### BACKGROUND OF THE INVENTION

Spraying systems utilizing a number of spray nozzles that are fed from a common header can be used in a wide variety of industrial applications. One example is cleaning filter assemblies used to filter process water or other fluids in general industrial applications. Such filter assemblies can be used, for instance, in the paper industry. These filter assemblies can be quite large and often include a number of filter elements that are arranged in closely spaced parallel relation.

To ensure efficient operation of the particular industrial process incorporating such filter assemblies, it is desirable to be able to the clean the filter elements without shutting down the process. To facilitate periodic cleaning of the filter elements, it is known to use a header with spray nozzles arranged on opposing sides of the header to discharge a cleaning fluid onto the individual filter elements. Generally, at least one header is arranged between each adjacent pairs of filter elements. In order to accommodate the header and spray nozzles, the filter elements must be spaced a sufficient distance apart to allow space for the header and opposed spray nozzles.

Unfortunately, however, providing space between the filter elements for the headers and spray nozzles can lead to a substantial increase in the overall size of the filter assembly. The size of the filter assembly can be a very important issue in the designing and laying out of the process equipment for applications utilizing such filters and, as a general principle, it is preferable for the filter assemblies to be as small as possible.

### BRIEF DESCRIPTION OF THE SEVERAL VIEWS OF THE DRAWINGS

FIG. 1 is a schematic perspective drawing of an illustrative filter assembly having a filter cleaning system including one or more spray nozzle assemblies according to the present invention.

FIG. 2 is an enlarged partial side view of the filter assembly of FIG. 1 showing how a header with a plurality of spray nozzle assemblies according to the invention can be arranged between an adjacent pair of filter elements.

FIG. 3 is a perspective view of one of the spray nozzle assemblies attached to the header of FIG. 2.

FIG. 4 is a side view of the spray nozzle of FIG. 3.

FIG. 5 is an end view of the spray nozzle assembly of FIG. 3.

FIG. 6 is a cross-sectional view of the spray nozzle assembly of FIG. 3 taken in the plane of line 6-6 in FIG. 5.

FIG. 7 is a cross-sectional view of the spray nozzle assembly of FIG. 3 taken in the plane of line 7-7 in FIG. 5.

FIG. 8 is a end view of the spray tip of the spray nozzle assembly of FIG. 3.

FIG. 9 is a perspective view of the retainer of the spray nozzle assembly of FIG. 3.

FIG. 10 is an end view of the retainer of the spray nozzle assembly of FIG. 3.

FIG. 11 is a perspective view of a clamp assembly for connecting the spray nozzle assembly of FIG. 3 to a header.

FIG. 12 is a side view of the clamp assembly of FIG. 11.

FIG. 13 is a cross-sectional view of the clamp assembly of FIG. 11 taken in the plane of line 13-13 in FIG. 12.

### DETAILED DESCRIPTION OF THE INVENTION

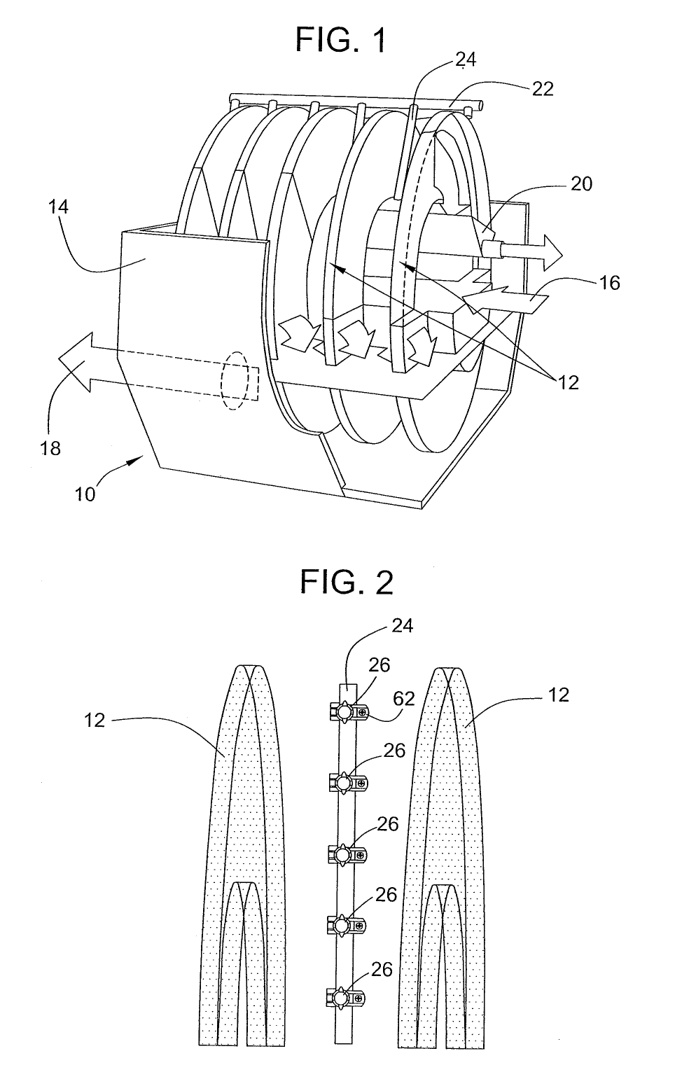

Referring now more specifically to FIG. 1 of the drawings, there is shown an illustrative filter assembly 10 having a filter cleaning system including one or more spray nozzle assemblies according to the present invention. While the present invention is described in connection with a filter cleaning application, it will be understood by those skilled in the art that the present invention is not limited to that application. To the contrary, as described in greater detail below, the present invention can be used in any application in which it may be desirable to discharge fluid in different directions.

The filter assembly 10 of FIG. 1 is configured for filtering process fluids, such as water, in industrial applications. The filter assembly 10 is of a known type. In general, the filter assembly 10 includes a plurality of individual, in this case disc shaped, filter elements 12 that are arranged in parallel spaced relation. The illustrated filter elements 12 are arranged in a housing 14 with “dirty” process water entering the filter assembly 10 through an inlet in one end of the housing (shown by the arrow 16 in FIG. 1) and “clean” process water exiting the filter assembly 10 through an outlet in an opposing end of the housing (shown by the arrow 18 in FIG. 1). To collect solid material that is washed off the filter elements 12, the filter assembly 10 includes a collection trough 20 that extends the length of the filter assembly through openings in the centers of the filter elements 12. The solid material collected in the trough 20 can exit the filter assembly through an outlet in the end of the filter assembly 10.

For washing material from the filter elements, the illustrated filter assembly 10 includes a cleaning system. In this case, the cleaning system includes a header assembly that has a main cleaning fluid supply line 22 to which a plurality of headers 24 are connected with each header supporting a plurality of spray nozzle assemblies 26. The headers 24 in the illustrated embodiment are arranged so that cleaning fluid is discharged onto both sides of each of the filter elements 12. In this arrangement, a single header 24 extends between each adjacent pair of filter elements 12 (see also FIG. 2). To help ensure complete cleaning coverage of the filter elements 12, the header assembly may be configured to rotate relative to the axis extending through the center of the plurality of filter elements. Additionally, the filter elements 12 also could be rotatable.

In accordance with one important aspect of the present invention, the spray nozzle assemblies 26 supported on the header 24 are configured so that each individual spray nozzle assembly is capable of discharging fluid in at least two different, in this case opposing, directions. In the illustrated embodiment, each spray nozzle assembly 26 has two discharge orifices 28 that are oriented so as to discharge in a transverse direction relative to the direction of fluid travel into the spray nozzle assembly 26. With conventional filter cleaning systems, the headers extending between filter elements have a number of spray nozzle assemblies oriented to discharge toward one of the filter element and a number of spray nozzle assemblies oriented to discharge toward the other filter element. Typically, the spray nozzle assemblies for one filter element extend outward from one side of the header and the spray nozzle assemblies for the other filter element extend outward from the other side of the header. Since the disclosed spray nozzle assembly 26 can discharge fluid in two opposed directions, the spray nozzle assemblies 26 can be arranged to extend outward from the header 24 in a direction parallel to the filter elements 12 and within the width of the header 24, as shown in FIG. 2, resulting in a much narrower footprint. This allows the filter elements 12 to be spaced closer together reducing the overall size of the filter assembly 10 while maintaining the same spray discharge patterns. Additionally, since a single spray nozzle assembly 26 according to the invention can replace two spray nozzle assemblies in a conventional filter cleaning system, fewer components can be used.

In the illustrated embodiment, the spray nozzle assembly 26 includes a nozzle body 30 that has a central fluid passageway 32 extending from an upstream open end 34 of body 20 as shown in the cross-sectional view of FIG. 6. The central fluid passageway 32 terminates at an end wall 36 at the downstream end of the nozzle body 30. A short distance upstream from the end wall 36 two transverse discharge passageways 38 extend outward from the central fluid passageway 32 in perpendicular relation thereto. Each transverse discharge passageway 38 is defined by a respective spray tip 40 that is mounted to the nozzle body 30 and that terminates in a discharge orifice 28, which in this case is formed by a V-shaped cut in the forward end of the spray tip. In the illustrated embodiment, the longitudinal axes of the two transverse discharge passageways 38 and the associated discharge orifices 28 are arranged such that they are in the same transverse plane (relative to the longitudinal axis of the central fluid passageway 32) and in the same longitudinal plane (again relative to the longitudinal axis of the central fluid passageway 32). As a result, the illustrated transverse discharge passageways 38 and their associated discharge orifices 28 are in directly opposed relation. The discharge orifices 28 can be configured for any desired spray pattern, e.g. full cone, flat spray, hollow cone, etc., and any desired spray angle and flow rate. In particular, the spray tips 40 and discharge orifices 28 can be configured to provide equivalent, or even better, performance to the conventional spray nozzle assemblies currently used, for example, in filter cleaning applications,

It will be appreciated that the invention is not limited to arrangements where the spray nozzle assembly 26 discharges is two directly opposed directions. For instance, the discharge orifices 28 may be offset from each other relative to a plane transverse to the central fluid passageway 32 and/or relative to a plane extending longitudinally relative to the central fluid passageway 32 so that the discharge orifices 28 are not in directly opposed relation. Moreover, it is conceivable that the spray nozzle assembly 26 could include more than two discharge orifices 28. In some arrangements or applications, it also may be desirable to plug one or more of the discharge orifices 28 so that spray nozzle assembly discharges in fewer than the total possible number of directions. For example, in a filter cleaning system application, there may be locations within the system where it is only necessary to discharge the cleaning fluid in a single direction. In such locations, to avoid having to provide a separate type of spray nozzle assembly, it may be desirable to provide one of the disclosed spray nozzle assemblies 26 but with a plug provided in place of one of the spray tips 40.

According to another aspect of the invention, to ease assembly of the spray nozzles assemblies 26 and to help ensure proper alignment of the discharge orifices 28, the spray tips 40 that define the discharge orifices can be received in complementary cylindrical retainers 42 that, in turn, can be secured to the nozzle body 30 (see FIG. 6). Advantageously, this arrangement allows the spray tips 40 to be made of a ceramic material while the retainers 42 can be made of a plastic material that can be ultrasonically welded to the nozzle body 30. In contrast to a connection method such as threaded connection that may loosen during use, ultrasonic welding provides a good rigid, stable connection that will keep the spray tips 40 in the proper orientation over time. The ultrasonic welding also provides a hermetic seal between the nozzle body 30 and the retainers 42 that eliminates the need for a separate o-ring or gasket. Additionally, to help ensure proper orientation of the spray tips 40 in the nozzle body 30, the spray tips 40, retainers 42 and nozzle body 30 can be provided with alignment features. These alignment features along with the ultrasonic welding can eliminate many handling difficulties associated with the manufacture and assembly of the spray nozzle assembly 26 and result in more accurate positioning of the spray tips 40, and thus the discharge orifices 28, which is essential for optimal performance.

In the illustrated embodiment, to ensure proper alignment of the retainer 42 relative to the nozzle body 30, a portion 44 of the outer surface of the retainer 42 is flat (see, e.g., FIGS. 4, 9 and 10). This flat portion 44 of the outer surface of retainer 42 is complementary to a flat portion in the perimeter wall of the opening in the sidewall of the nozzle body 30 in which the retainer 42 is received (see FIG. 4) such that the retainer 42 can be inserted in the opening in the nozzle body 30 in only one predetermined orientation. The illustrated retainer 42 has a generally cylindrical configuration that defines an inner pocket 46 for receiving the spray tip 40. The retainer 42 including the pocket 46 has an open downstream end 47 (see FIG. 10) in which the spray tip 40 can be inserted and a downstream end 48 with a smaller opening (see FIG. 9) through which the downstream end of the spray tip 40 with the discharge nozzle 28 protrudes (see, e.g., FIG. 6).

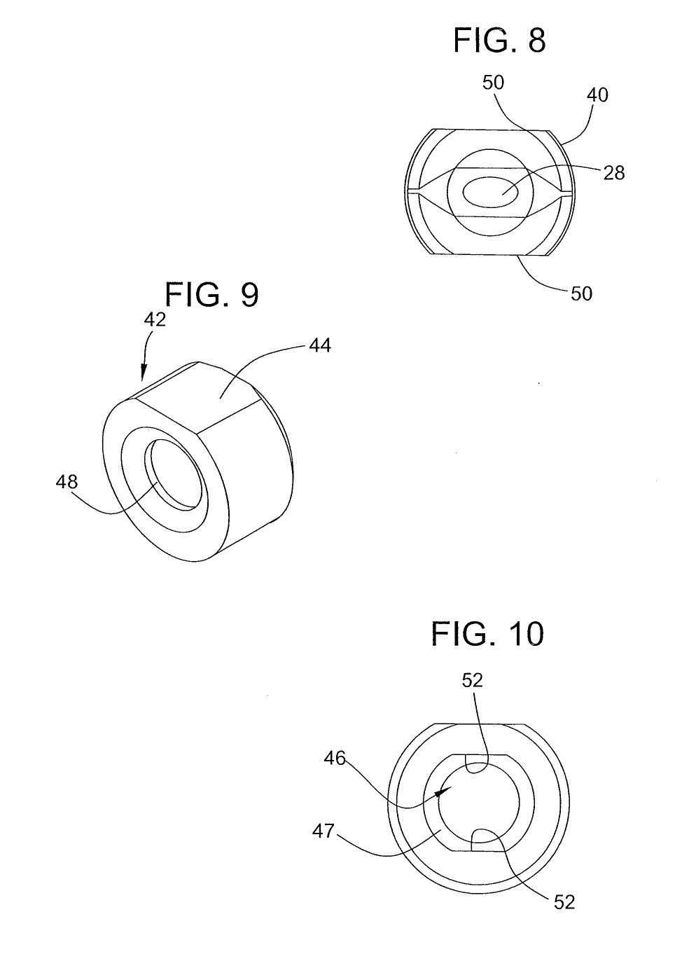

For ensuring proper alignment of the spray tip 40 relative to the retainer 42, the spray tip 40 includes two flat sides 50 (see FIG. 8) that are complementary to two flat portions 52 in the inner wall of the pocket 46 in the retainer 42 for receiving the spray tip (see FIG. 10). In the illustrated embodiment, the complementary flat portions 50, 52 in the spray tip 40 and in the pocket 46 of the retainer 42 are configured such that the spray tip 40 can only be inserted in the retainer 42 in two orientations. Since the discharge orifice 28 of the illustrated spray tip 40 is symmetrical, the spray tip 40 will be properly oriented relative to the retainer 42 in either of the two positions. Of course, those skilled in the art will appreciate that the described alignment features are merely examples of the type of structures that could be used to ensure that the retainer 42 and spray tip 40 are properly oriented relative to each other and the nozzle body 30 and the other alignment structures could be used.

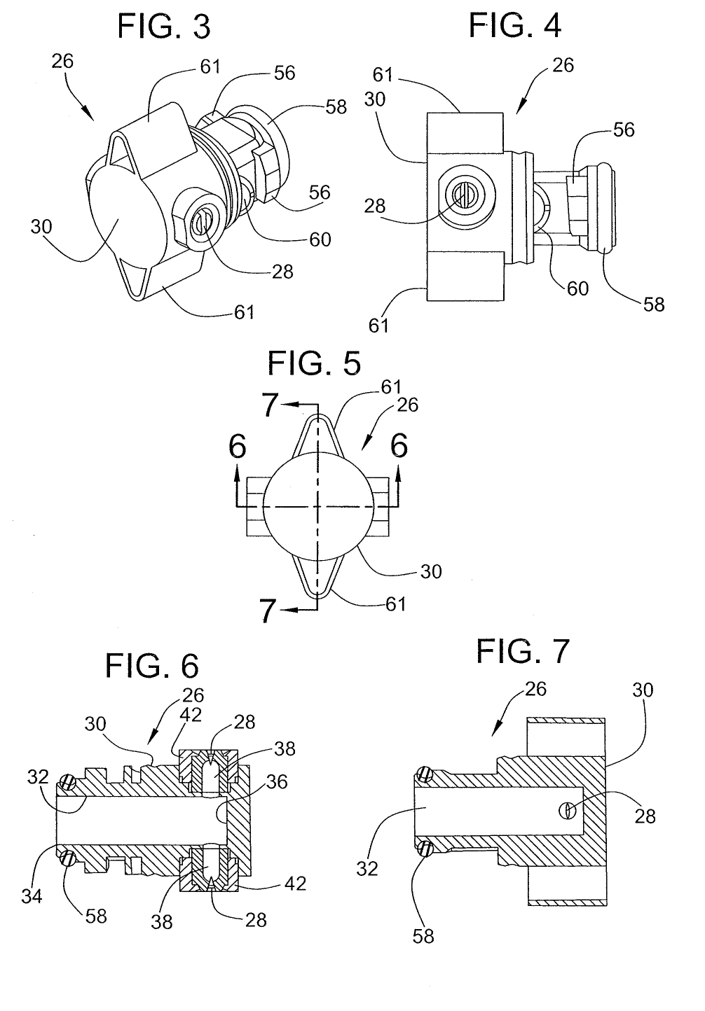

For connecting the spray nozzle assembly 26 to a mating receptacle 53 that can communicate with a fluid supply, the nozzle body 30 includes a connecting stem 54 configured for quick engagement and disengagement. In particular, the connecting stem 54 of the illustrated nozzle body 30 is configured with camming elements, in this instance in the form of a pair of outwardly extending and diametrically opposed camming lugs 56 (see FIGS. 3 and 4), that engage with complementary camming elements in the mating receptacle 53 when the nozzle body 30 is inserted into the receptacle 53 and the nozzle body 30 is turned relative to the receptacle 30. The complementary camming elements act to draw the nozzle body 30 into the receptacle 53 and hold the nozzle body 30 and receptacle in assembled relation until the nozzle body 30 is turned in the opposite direction relative to the receptacle in order to remove the nozzle. As the nozzle body 30 is drawn into the receptacle, an o-ring seal 58 carried on the far upstream end of the connecting stem 54 is pressed into engagement with the mating receptacle to establish a seal between the outside of the nozzle body and inside of the receptacle. In the illustrated embodiment, the connecting stem 54 of the nozzle body 30 further includes a pair of detents 60 (see FIGS. 3 and 4) that can interact with complementary detents in the receptacle to further facilitate releasable retention of the nozzle body in the mating receptacle. To facilitate turning of the spray nozzle assembly 26 relative to the mating receptacle, a pair of diametrically opposed wings 61 are integrally formed into the body 30 of the spray nozzle assembly (see, e.g., FIGS. 3 and 5). Additional details regarding the configuration and operation of the illustrated connecting stem and the complementary receptacle are disclosed in commonly assigned U.S. Pat. No. 5,727,739 which is hereby incorporated herein by reference.

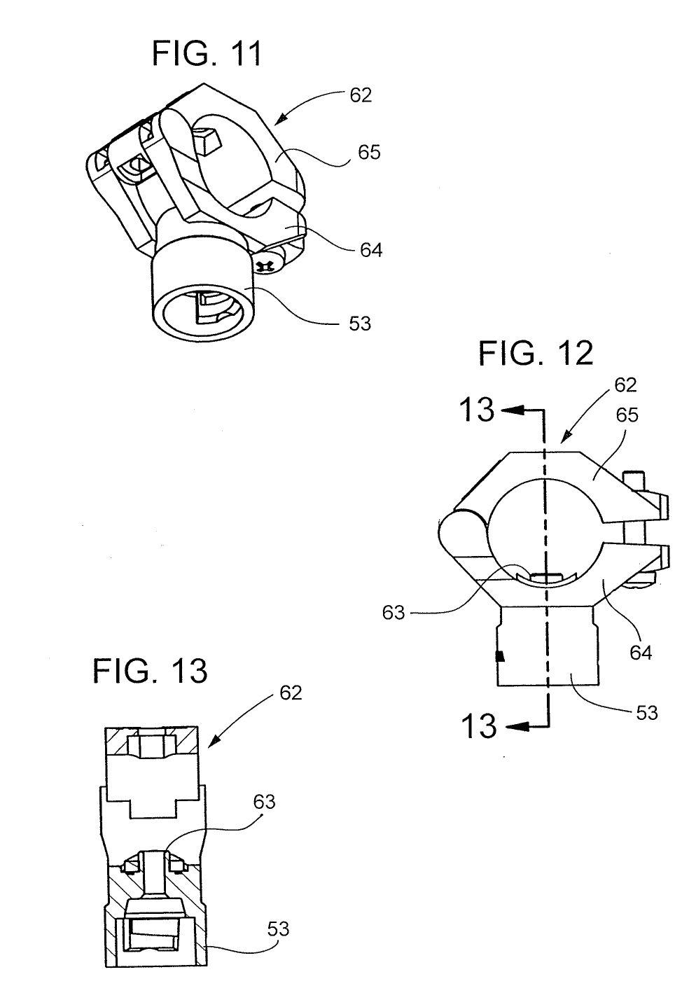

For mounting the spray nozzle assemblies 26 on the header 24, the receptacle 53 for receiving the spray nozzle assembly in this case is part of a clamp assembly 62 (see FIGS. 11-13) that is connectable to the header 24. The open portion of the receptacle 53 communicates with a stem 63 on the clamp assembly 62 that is receivable in an orifice in the sidewall of the header. The clamp assembly 62 includes first and second clamping members 64, 65 that cooperate with each other so as to fit around the header. The two clamping elements 64, 65 are drawn toward each other and into tight engagement with the header by a screw which passes through the first clamping element 64 and is threaded into the second clamping element 65. An o-ring can be provided on the stem 63 of the clamp assembly 62 and as the clamp members are tightened the o-ring can be pressed into tight sealing engagement with the edge of the orifice in the header. It will be appreciated by those skilled in the art that the illustrated clamp assembly is but one example of how a spray nozzle according to the present invention could be connected to a header or other pipe. For example, instead of using a separate clamp, the nozzle body could have threads that would enable a direct connection to a header or other pipe.

While the present invention has been described in the context of an illustrative filter cleaning application, those skilled in the art will appreciate that the present invention is not limited to use in only that application. To the contrary, the spray nozzle assembly of the present invention could be used in any application involving spray nozzles that discharge in multiple directions. For example, a single spray nozzle assembly according to the present invention could be used to replace two oppositely directed spray nozzles in any desired application.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A spray nozzle comprising:
a nozzle body including a fluid passageway extending from an upstream opening in the nozzle body, the fluid passageway having a longitudinal axis; and
a plurality of spray tips each supported on the nozzle body, each spray tip having a discharge orifice in communication with the fluid passageway and configured to discharge fluid in a direction that is transverse to the longitudinal axis of the fluid passageway.

2. The spray nozzle of claim 1 wherein the nozzle body includes at least two spray tips with discharge orifices configured to discharge fluid in opposed directions.

3. The spray nozzle of claim 1 wherein each spray tip is received in a complementary retainer that is secured to the nozzle body.

4. The spray nozzle of claim 3 wherein the spray tips are made of a ceramic material and the retainers are made of a plastic material.

5. The spray nozzle of claim 4 wherein the retainers are secured by ultrasonic welding to the nozzle body.

6. The spray nozzle of claim 3 wherein each retainer and nozzle body are configured such that the retainer can only be secured to the nozzle body in a defined relative orientation.

7. The spray nozzle of claim 6 wherein an outer wall of the retainer includes a flat portion that is complementary to a flat portion in a receiving opening in the nozzle body such that the retainer can only be secured in the receiving opening of the nozzle body in a defined relative orientation.

8. The spray nozzle of claim 3 wherein each retainer and its associated spray tip are configured such that the spray tip can only be received in the retainer in a defined relative orientation.

9. The spray nozzle of claim 8 wherein a receiving opening in the retainer has one or more flat portions that are complementary to one or more flat portion on an outer surface of the spray tip such that the spray tip can only be received in the receiving opening in the retainer in a defined relative orientation.

10. A spray system comprising:
a header including a fluid supply passage;
a plurality of spray nozzles arranged in spaced relation along the header, each spray nozzle comprising:
a nozzle body supported on and extending outward from the header, the nozzle body including a fluid passageway extending from an upstream opening in the nozzle body, the fluid passageway having a longitudinal axis;
and a plurality of spray tips each supported on the nozzle body, each spray tip having a discharge orifice in communication with the fluid passageway and configured to discharge fluid in a direction that is transverse to the longitudinal axis of the fluid passageway.

11. The spray system of claim 10 wherein connecting stems of the nozzle bodies of the spray nozzles are received in mating receptacles supported on the header.

12. The spray system of claim 11 wherein each mating receptacle is part of a clamp assembly that is clamped to the header.

13. The spray system of claim 10 wherein the nozzle body includes at least two spray tips with discharge orifices configured to discharge fluid in opposed directions.

14. The spray system of claim 10 wherein each spray tip is received in a complementary retainer that is secured to the nozzle body.

15. The spray system of claim 14 wherein the spray tips are made of a ceramic material and the retainers are made of a plastic material.

16. The spray system of claim 15 wherein the retainers are secured by ultrasonic welding to the nozzle body.

17. The spray system of claim 14 wherein each retainer and nozzle body are configured such that the retainer can only be secured to the nozzle body in a defined relative orientation.

18. The spray system of claim 17 wherein an outer wall of the retainer includes a flat portion that is complementary to a flat portion in a receiving opening in the nozzle body such that the retainer can only be secured in the receiving opening of the nozzle body in a defined relative orientation.

19. The spray system of claim 14 wherein each retainer and its associated spray tip are configured such that the spray tip can only be received in the retainer in a defined relative orientation.

20. The spray system of claim 19 wherein a receiving opening in the retainer has one or more flat portions that are complementary to one or more flat portion on an outer surface of the spray tip such that the spray tip can only be received in the receiving opening in the retainer in a defined relative orientation.
